(19) United States
(12) Patent Application Publication
(10) Pub. No.: US 2008/0271155 A1
(43) Pub. Date: Oct. 30, 2008

(54) METHOD AND APPARATUS FOR OBTAINING DRM CONTENT PACKETS

(75) Inventors: Pei Dang, Shenzhen (CN); Yimin Li, Shenzhen (CN); Wenjie Feng, Shenzhen (CN)

Correspondence Address: BRINKS HOFER GILSON & LIONE, P.O. BOX 10395, CHICAGO, IL, 60610, US

(73) Assignee: Huawei Technologies Co., Ltd., Shenzhen (CN)

(21) Appl. No.: 12/169,325

(22) Filed: Jul. 8, 2008

(30) Foreign Application Priority Data
Jan. 26, 2006 (CN) 200610033416.9
Jan. 23, 2007 (CN) PCT/CN2007/000240

(51) Int. Cl. G06F 1/00

(52) U.S. Cl. 726/26

(57) ABSTRACT

A method for obtaining DRM content packets is provided. The method enables a terminal to obtain another DCF when the terminal is unable to use a downloaded DCF. The method includes receiving the first content packet, which includes media content types and corresponding URLs, and resolving the first content packet; selecting a media content type and the corresponding URL in the first content packet; downloading the second content packet from the selected URL.

This application claims a priority from the Chinese Patent Application No. 200610033416.9, filed with the Chinese Patent Office on Jan. 26, 2006 and entitled “Method and Apparatus for Obtaining DRM Content Packets”, contents of which are incorporated herein by reference in their entirety.

### FIELD

The present embodiments relate to obtaining digital rights management (DRM) content packets.

### BACKGROUND

Digital rights management (DRM) is a rights protection technology for digital contents. DRM provides a control that protects the private data of a content provider (CP) against illegal reproduction and use and prevents the digital contents from being reproduced, copied, and transferred illegally through networks and computers.

The DRM technology controls distributing, transmitting, and using digital contents. The DRM technology is used so that the digital contents are used by only authorized persons. The content issuer (CI) encrypts the digital contents, packages the digital contents in a certain format, and uploads the packaged digital contents to the network. To use the digital contents, a user applies to the rights issuer (RI) for a rights object (RO) associated with the digital contents. The RO includes the relevant keys that are used to decrypt the digital contents, and the rights of using the digital contents. The user cannot use the purchased contents until the user holds the digital contents and RO.

The DRM content format (DCF) is a DRM content packet based on the International Organization for Standardization (ISO) base media file format. The DRM content packet includes protected media contents and relevant metadata. Media contents may be videos and audios, and metadata is DRM-related data. The same media content may be presented in multiple formats such as mp3, wav, and midi and at different resolutions, thus generating different DCF packets.

A terminal may be unable to use a downloaded DCF because of software and hardware conditions. The user may need to download a new DCF.

Super distribution relates to the distribution of a DCF from one terminal to another. For example, user A may send a DCF to user B through super distribution. User A is unable to know the terminal capability of user B. Accordingly, the terminal of user B may be unable to support the type of the sent DCF media contents. User B needs to download a new DCF.

As requirements on multimedia information increases, users expect videos and audios of higher quality, and may also need to download a new DCF.

The DCF structure provides a user with another address—unique resource locator (URL) to obtain an optional DCF:

ContentURL=“ContentURL” “:” content-url

content-url=token

If a terminal does not support the type of a downloaded DCF, the user may download another version of the DCF (for example, different resolutions, different code formats) for the same media content through content-url.

Although an optional address for downloading a DCF is provided, the type of the DCF to be downloaded is unknown to the terminal, and the terminal is unable to select according to its software and hardware capabilities. The DCF downloaded may be still unavailable for the terminal.

### SUMMARY

The present embodiments may obviate one or more of the limitations or drawbacks inherent in the related art. For example, in one embodiment, information about a corresponding media content type is provided with the content-url. In another example, the present embodiments relate to obtaining DRM content packets, and enables downloading of an applicable DCF when a terminal does not support a downloaded DCF, so that the downloaded media content type may better meet the service requirements.

In one embodiment, a method for obtaining DRM content packets includes: receiving a DCF packet including optional media content types and the corresponding URLs; obtaining optional media content types contained in the DCF and the corresponding URLs, selecting a new media content type if the terminal determines that the DCF does not include media content or the media content included in the DCF is unavailable; and downloading DCF packets from a content issuer according to the URL corresponding to the selected media content type.

In one embodiment, a method for obtaining DRM content packets includes: receiving a DCF packet including optional media content types and the corresponding URLs; displaying the optional media content types and the corresponding URLs according to a preset rule; obtaining a user command; selecting a media content type according to the user command, and downloading DCF packets from a content issuer according to the URL corresponding to the selected media content type.

In one embodiment, a terminal apparatus includes: a download agent unit, a DRM agent unit, and a DCF selecting unit. The download agent unit is adapted to control the download of a DCF according to a determined URL. The DRM agent unit is adapted to resolve the downloaded DCF, and extract the optional media content types and corresponding URLs when the terminal apparatus determines that the media content in the DCF is unavailable. The DCF selecting unit is adapted to select the determined media content type among the optional media content types extracted by the DRM agent unit, and send the URL corresponding to the selected media content type to the download agent unit.

In one embodiment, a terminal apparatus includes: a download agent unit, a resolving unit, a displaying unit, an inputting unit, and a DCF selecting unit. The download agent unit is adapted to control the download of a DCF according to a determined URL. The resolving unit is adapted to resolve the downloaded DCF and extract the optional media content types and the corresponding URLs included in the DCF. The displaying unit is adapted to display the optional media content types and the corresponding URLs extracted by the resolving unit according to a preset rule. The inputting unit is adapted to input user commands including a first user command indicating a media content type selected by user, and send the first user command to the DCF selecting unit. The DCF selecting unit is adapted to select the media content type according to the user command, and send the URL corresponding to the selected media content type to the download agent unit.

In one embodiment, the DRM content packet provides more than two URLs, and includes the media content type of each URL. A user or a terminal apparatus may select a new DCF of a proper type for downloading. The selection may be based on the media content type information and the personal conditions or preference. This ensures the new downloaded DCF is available, and avoids invalid downloads, which may reduce network load and improve the user's experience.

A user may delete the actual media contents in the DCF at the time of super distribution (e.g., before sending), which may reduce the network load and the sending duration. The recipient may download the complete DCF using the information of the media content types and corresponding URLs available from the DCF.

### BRIEF DESCRIPTION OF THE DRAWINGS

FIG. 1 shows one embodiment of reselecting a DCF for downloading after downloading an unavailable DCF;

FIG. 2 shows one embodiment of reselecting a DCF for downloading after receiving a super-distributed DCF;

FIG. 3 shows one embodiment of the structure of the first terminal; and

FIG. 4 shows one embodiment of the structure of the second terminal.

### DETAILED DESCRIPTION

In one embodiment, a DRM content format (DCF) packet includes more than one optional URL and the corresponding media content type. Each type corresponds to a specific URL. When a terminal is unable to use a downloaded DCF, the terminal user may choose (select) to download a supported media content type, or the terminal may select a supported media content type automatically. Selecting a supported media content type ensures that the second DCF downloaded by the user is available.

The following is an example of the DCF structure:

ContentURL = “ContentURL” “:” ContentType1 “;” content-url1

“;” ContentType2 “;” content-url2
......

“;” ContentTypeN “;” content-urlN

ContentType1......N = token
content-url1.........N = token

In the foregoing example, if the terminal (or terminal user) selects the DCF whose media content type is ContentType2, the terminal may download it from the URL directed by content-url2.

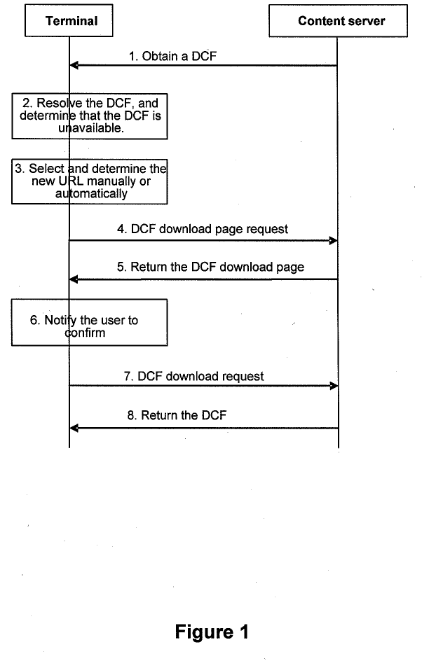

In one embodiment, when the DCF downloaded by a terminal from a content issuer is unavailable, the terminal reselects a DCF for downloading. FIG. 1 illustrates reselecting a DCF for downloading.

As shown in FIG. 1, the terminal obtains a DCF packet from the content issuer (“1.”). The DCF packet may be ordered by the user. The terminal resolves the DCF, determines that the media content types in the DCF are not supported by the terminal, and extracts multiple media content types and the corresponding UTRLs from the DCF (“2.”). The terminal may display relevant information to the user, indicating that the DCF is unavailable. The terminal selects a media content type and the corresponding URL from the extracted multiple media contents (“3.”). The media content type may be selected by (1) displaying the supported media content types with the terminal, and the user selecting one of them (“manually”) or (2) automatically selecting a media content type according to a certain rule with the terminal (“automatically”). For example, the media content type may be automatically selected according to the sequence of the URLs in the DCF, or the media content types supported by the terminal and the preset sequence. The terminal may send a DCF download page request to the content issuer according to the selected content type and the corresponding URL (“4.”). The request message may include the foregoing (corresponding) URL. The content issuer may return the download page to the terminal (“5.”). The terminal may display the received download page, and asks (requests) the user for confirmation (“6.”). If the user confirms the download, the terminal sends a DCF download request to the content issuer (“7.”). The content issuer encapsulates the content ID, URL and media content into a DCF, and sends the DCF to the terminal; or sends an pre-packaged DCF to the terminal directly (“8.”).

The user may obtain a new available DCF.

The duration of super distribution may be reduced. The sender may delete the actual media content data in the DCF before sending. The sent DCF packet may include only the types of the content of different versions, the corresponding URLs, and other header information. The receiving terminal apparatus may choose to download the DCF of a proper version.

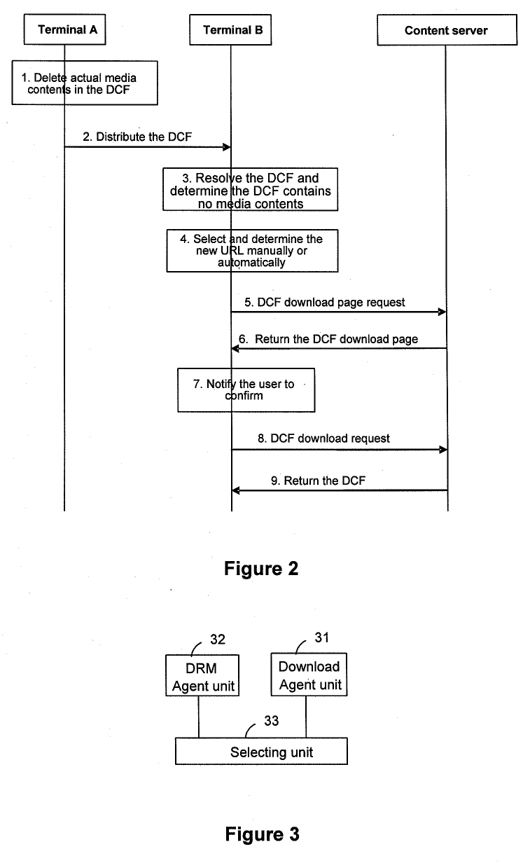

In one embodiment, user A distributes a DCF including no actual media contents to user B. FIG. 2 shows the message flow of distributing a DCF.

As shown in FIG. 2, terminal A deletes the actual media contents in the DCF packet (“1.”). Terminal A sends the foregoing DCF without media contents to terminal B (“2.”). Terminal B resolves the received DCF, and extracts the content types and the corresponding URLs contained in the DCF upon discovering that the media content is empty; and may display relevant information to the user, indicating that the DCF media content is empty (“3.”). Terminal B selects a media content type and the corresponding URL from the extracted media content types (“4.”). The media content type may be selected either by displaying the supported media content types with the terminal, and the user selecting one of them; or the terminal selects one automatically according to a certain rule (for example, according to the sequence of the URLs in the DCF, or the media content types supported by the terminal and the preset sequence). Terminal B sends a DCF download page request to the content issuer according to the selected content type and the corresponding URL (“5.”). The request message may include the foregoing URL. The content issuer returns the download page to terminal B (“6.”). Terminal B displays the received download page, and asks the user for confirmation (“7.”). If the user confirms the download, terminal B sends a DCF download request to the content issuer (“8.”). The content issuer encapsulates the content ID, URL and media content into a DCF, and sends the DCF to terminal B; or sends an pre-packaged DCF to terminal B directly (“9.”).

The user B may obtain a new available DCF.

The foregoing embodiments are only exemplary embodiments. Other embodiments may be used. For example, in one embodiment, a DCF receiving method is adopted by a terminal apparatus separately. The terminal determines whether the received DCF includes any media contents. If the DCF does not include media contents, the terminal extracts the media content types and the corresponding URLs contained in the DCF; and may display the relevant information to tell the user that the DCF media content is empty.

The terminal may select a content type and the corresponding URL from the extracted media content types, and send a DCF download page request to the content issuer according to the selected content type and the corresponding URL, in which the request message contains the URL. Upon receiving the download page sent by the content issuer, the terminal sends a DCF download request to the content issuer if the user confirms the download.

If the terminal determines that the DCF contains media contents, the terminal may determine whether the contents are available. For example, the terminal may determine whether the terminal supports the type of the media contents. If the contents are not available, the terminal extracts the optional media content types and the corresponding URLs contained in the DCF. The terminal may display the relevant information to tell the user that the DCF is unavailable. The terminal may then proceed with act 3 and the following steps of the first embodiment, including selecting a content type and the corresponding URL from the extracted ones, and sending a DCF download page request to the content issuer according to the selected content type and the corresponding URL, in which the request message contains the URL. Upon receiving the download page sent by the content issuer, the terminal sends a DCF download request to the content issuer if the user confirms the download.

The one embodiment, the terminal does not need to determine whether the DCF includes any media content, nor does it need to further determine support of the type of the media content contained in the DCF. After resolving the DCF, the terminal displays the relationships between all media content types and the URLs included in the DCF directly, or displays those supported by the terminal. In addition, after display, the terminal selects a media content type according to the user command, and performs the download according to the URL corresponding to the media content type.

FIG. 3 shows a terminal apparatus. The terminal apparatus includes a DRM agent unit, selecting unit 33, and a download agent 34.

The DRM agent unit 32 is operable to receive a first content packet, which includes media content types and the corresponding URLs, and resolve the first content packet. The first content packet is received from a content issuer or another terminal.

The selecting unit 33 is operable to select a media content type and the corresponding URL contained in the first content packet. The selecting unit selects a media content type and the corresponding URL according to a input of user or selects a media content type and the corresponding URL automatically. The possible selection modes are: selecting automatically according to the sequence of the media content types and the corresponding URLs in the first content packet or selecting automatically according to a preset selection sequence.

The download agent unit 31 is operable to download the second content packet from the selected URL.

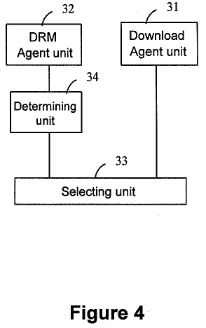

FIG. 4 shows a terminal apparatus with a determining unit 34. The determining unit 34 may determine that the first content packet includes no media content, or may determine that the terminal does not support the type of the media content in the first content packet. The determining unit 34 may notify the selecting unit 33 to select a media content type and the corresponding URL.

Although the invention has been described through some exemplary embodiments, the invention is not limited to such embodiments. It is apparent that those skilled in the art can make various modifications and variations to the present invention without departing from the spirit and scope of the present invention. The present invention is intended to cover these modifications and variations provided that they fall in the scope of protection defined by the following claims or their equivalents.

What is claimed is:

1. A method for obtaining DRM content packets, comprising:
receiving a first content packet, which comprises media content types and the corresponding URLs with a terminal,
resolving the first content packet;
selecting a media content type and the corresponding URL in the first content packet; and
downloading a second content packet from the selected corresponding URL.

2. The method of claim 1, wherein the terminal selects the media content type and the corresponding URL in the first content packet when the terminal determines that the first content packet comprises no media content.

3. The method of claim 1, wherein the terminal selects the media content type and the corresponding URL according to an input of a terminal user.

4. The method of claim 1, wherein the terminal automatically selects the media content type and the corresponding URL according to the sequence of media content types and corresponding URLs in the first content packet.

5. The method of claim 1, wherein the terminal receives the first content packet from a content issuer or another terminal.

6. The method of claim 1, wherein the terminal selects the media content type and the corresponding URL in the first content packet when the terminal determines that the terminal does not support the type of the media content in the first content packet after resolving the first content packet.

7. The method of claim 1, wherein the terminal automatically selects the media content type and the corresponding URL according to a preset selection sequence.

8. A terminal apparatus, comprising:
a DRM agent unit that is operable to receive a first content packet, which comprises media content types and the corresponding URLs and resolve the first content packet;
a selecting unit that is operable to select a media content type and the corresponding URL in the first content packet; and
a download agent unit that is operable to download a second content packet from the selected URL.

9. The apparatus of claim 8, further comprising:
a determining unit that is operable to determine that the first content packet does not include media content, and notify the selecting unit to select a media content type and the corresponding URL when the first content packet does not include media content.

10. The apparatus of claim 8, wherein the selecting unit selects the media content type and the corresponding URL according to an input of user.

11. The apparatus of claim 8, wherein the selecting unit automatically selects the media content type and the corresponding URL according to a sequence of media content types and corresponding URLs in the first content packet.

12. The apparatus of claim 8, wherein the DRM agent unit receives the first content packet from a content issuer or another terminal.

13. The apparatus of claim 8, further comprising: a determining unit that is operable to determine that the terminal does not support a type of the media content in the first content packet, and notify the selecting unit to select a media content type and the corresponding URL when the terminal does not support the type of the media content in the first content packet.

14. The apparatus of claim 8, wherein the selecting unit automatically selects a media content type and the corresponding URL according to a preset selection sequence.

15. A method for obtaining DRM content packets, comprising:
receiving a first content packet, which comprises:
a first media content type and a corresponding first URL, and
a second media content type and a corresponding second URL;
resolving the first content packet;
selecting a first media content type and the first corresponding URL in the first content packet; and
downloading a second content packet from the selected corresponding URL.

16. The method of claim 15, wherein selecting the first media content type includes selecting the first media content type and the first corresponding URL when the first content packet comprises no media content or a type of the media content in the first content packet after resolving the first content packet is not supported by a terminal.

17. The method of claim 15, wherein the terminal selects the media content type and the corresponding URL according to an input of a terminal user.

18. The method of claim 15, wherein selecting the first media content type includes automatically selecting the first media content type and the corresponding first URL according to a sequence of the first and second media content types and corresponding first and second URLs in the first content packet or automatically selecting the first media content type and the corresponding first URL according to a preset selection sequence.

19. The method of claim 15, wherein the terminal receives the first content packet from a content issuer or another terminal.
